(19) United States
(12) Patent Application Publication
(10) Pub. No.: US 2018/0353367 A1
(43) Pub. Date: Dec. 13, 2018

(54) MOBILITY ASSISTANCE SYSTEM

(71) Applicant: KUKA Roboter GmbH, Augsburg (DE)

(72) Inventor: Martin RIEDEL, Augsburg (DE)

(21) Appl. No.: 15/780,429

(22) PCT Filed: Nov. 22, 2016
(86) PCT No.: PCT/EP2016/078399

§ 371 Date: May 31, 2018

(30) Foreign Application Priority Data
Dec. 1, 2015 (DE) 10 2015 223 883.0

(51) Int. Cl. A61H 3/04

(52) U.S. Cl. CPC A61H 3/04; A61H 2003/043; A61H 2201/5007; A61H 2003/046; A61H 2201/0192; A61H 2201/0107; A61H 2201/1207

(57) ABSTRACT

A mobility assistance system includes a drive unit, a modular structural frame having a central module, and at least one side module. The central module is configured to drive at least one wheel of the mobility assistance system. The drive unit is arranged in one of the central module or the at least one side module and the at least one wheel is associated with the side module. The central module and the at least one side module each have at least one interface, by means of which the central module can be reversibly coupled mechanically electronically to the at least one side module.

The present invention relates to a mobility assistance system which has enhanced tipping stability and the width of which is changeable, and a method for changing the width of the mobility assistance system.

### BACKGROUND OF THE INVENTION

Mobility restrictions due to physical impairments are caused by accidents, illnesses, and by the aging process. In particular in the context of the aging society, the number of affected humans increases and creates a greater and greater social and economic problem. Age or illnesses frequently result in a loss of physical strength, which is usually accompanied by a reduction of physical activity. As a consequence, the affected humans not only lose further strength, but rather also lose coordination capability, which frequently ends in a need for care.

One important goal of preventative health in old age is therefore maintaining mobility. The most successful technical problem up to this point for assisting the mobility for this target group is a Rollator. A Rollator is a passive device which is set into motion by the user.

Rollators and other, similar apparatuses are used in particular to assist the walking function and are used for weak (older) persons and, for example, as a rehabilitation measure after an operation or as assistance in the event of age-related restriction of the walking function. Rollators are to be used in this case as a stable support when walking. However, known Rollators only achieve this stability in the event of a vertical load of the handles. In contrast, if a transverse load is applied to the relator, i.e., a horizontal force on the handles, tipping of the Rollator thus frequently occurs and severe falls thus frequently occur. Known Rollators have an intrinsic weight of 5 to 10 kg and have small footprints, to be sufficiently maneuverable and transportable. A Rollator can thus al-ready tip over locked wheels of the Rollator from a force of approximately 12 N, which engages horizontally on the handles. This is the case, for example, if a seated person on the Rollator wishes to pull themselves up to standing. The Rollator can also tip very easily if a person supports themselves laterally thereon. Moreover, the wheels of the relator tend to slip away when a sufficiently high vertical force is not applied to the Rollator. In this case, the brakes which lock the wheels and are to prevent the Rollator from moving away are ineffective, since the Rollator slips away. This can result in falls and/or uncoordinated movements of the person who guides the Rollator. The object of the present invention is therefore to at least partially remedy the mentioned disadvantages and to provide a system which has a high level of tipping stability, is simple to transportation, and has a high level of maintenance and repair friendliness.

### DETAILED DESCRIPTION OF THE INVENTION

The object of the present invention is at least partially achieved by a mobility assistance system as claimed in claim 1 and by a method for changing a width of a mobility assistance system as claimed in claim 16.

The object is achieved in particular by a mobility assistance system, in particular in the nature of a Rollator, comprising a drive unit which is configured to drive at least one wheel of the mobility assistance system; a modular structural frame, wherein the modular structural frame comprises a central module and at least one side module, wherein the drive unit is arranged in the central module and/or the at least one side module, and wherein at least one wheel is associated with the side module. The central module and the at least one side module each have at least one interface, by means of which the central module can be reversibly coupled mechanically and/or electronically to the at least one side module.

Such mobility assistance systems are used in particular for walking assistance of older humans or are used for rehabilitation measures after an operation. A user can hold fast for this purpose to the mobility assistance system, and control it appropriately to walk in a desired direction. The at least one driven wheel of the mobility assistance system is used in this case in particular to compensate for the intrinsic weight of the mobility assistance system, and therefore the mobility assistance system may be pushed very easily by the user. The drive thus compensates for the inertia of the mobility assistance system during acceleration and/or deceleration, during cornering, and, for example, the downhill-slope force when walking on an incline. Further applications are also possible.

The drive unit preferably comprises software, electronics, and mechanisms and enables a control signal to be converted into a corresponding propulsion of the wheel. The wheel is preferably electrically driven in this case. The drive unit can be arranged in one of the modules (central module and/or side module) or the components of the drive unit can be distributed onto the modules. The energy store, which is typically a chargeable battery, is preferably arranged in the central module. The electrical drives of the wheels are preferably arranged in the side modules. The modular structural frame provides the mechanical stability of the mobility assistance system, and is used to accommodate the components of the mobility assistance system, for example, the drive unit and/or the wheels. The side module, with which at least one wheel is associated, defines an axle spacing of the wheels of the mobility assistance system. The mobility assistance system typically has at least three wheels, wherein the wheels are associated with a front axle or a rear axle. The axle spacing is the spacing between the front and the rear axles.

The interface, by means of which the central module can be reversibly coupled mechanically and/or electronically to the at least one side part, is used to disassemble the mobility assistance system rapidly and easily into the individual modules. The modules (central module and side modules) form units which are closed per se in this case. For example, a side module comprises a wheel, a drive associated with the wheel, and a line which connects an electronic interface to the drive. Data and/or power, for example, can be transmitted via the interface and the line. A computer unit, which controls the drive, and an energy store can be arranged in the central module in this case. If a defect occurs at one of the modules, the corresponding module can thus be replaced separately and maintained or repaired. A high level of availability of the mobility assistance system is thus ensured. Moreover, the modular structural frame facilitates the transportation of the typically heavy mobility assistance system. The transportation is simplified since the individual modules can be transported separately and can be coupled again at the usage location of the mobility assistance system. Thus, for example, the transportation and the loading of the mobility assistance system into a passenger automobile are simplified. Furthermore, the mobility assistance system can be adapted to the respective user by the replacement of individual modules. If, for example, modules of different sizes are available, the size of the structural frame can thus be adapted to the physical size of a person to be assisted. It is also possible to adapt the functionality of the mobility assistance system to the respective person. In particular, the mobility assistance system can be equipped by the replacement of individual modules and further functions can be provided to a user when they are required by the user. Functionalities of one production series can also be supplemented and/or replaced easily with the functionalities of another production series.

The interfaces of the central module and the at least one side module preferably comprise a data and/or drive power interface. Data interfaces are used to exchange data to or from the at least one side module. For example, data which are obtained in the at least one side module (for example, sensor data) can be transmitted to the central module by means of the data interface. Data, for example, control signals, can also be transmitted from the central module to the at least one side module. The drive power interface enables drive power to be transmitted from the central module to the at least one side module. The drive power can be transmitted in this case in the form of mechanical power, electrical power, pneumatic power, and/or the like. For example, the drive power interface can comprise a shaft, which provides the drive power for a driven wheel of the side module. The drive power interface can also comprise a cable or a plug which provides electrical energy for driving a wheel.

The interfaces of the central module and the at least one side module are preferably quick-mounting interfaces, which are configured to couple the central module to the at least one side module without tools. A tool-free coupling enables the coupling of the modules to the structural frame without using further aids, for example, tools. The coupling can thus be executed anywhere. The quick-mounting interfaces moreover enable rapid coupling of the modules. For example, the coupling can be executed by means of quick releases, by means of suitable bolt or pin connections, snap connections, and/or the like.

At least one part of the central module, when the central module is coupled to the at least one side module, is preferably mounted so it is vertically or horizontally movable in relation to the side module, to change a width of the mobility assistance system, wherein a horizontal movement of the at least one part of the central module is preferably perpendicular to the width. The relative movement of at least one part of the central module in relation to the side module enables a volume within the modular structural frame to be shifted such that the width of the mobility assistance system can be changed.

In particular since the modules (i.e., the at least one side module and the central module) have fixed volumes, collapsing of the mobility assistance system, as is known, for example, from conventional Rollators, is not possible. The space which is vacated by the displacement and/or pivoting of the at least one part of the central module can subsequently be occupied by the other parts of the central module and/or the at least one side module, in order to reduce the width of the mobility assistance system.

In particular, the complete central module can also be mounted so it is vertically or horizontally movable. If only a part of the central module is mounted so it is movable, the interfaces between central module and the at least one side module thus remain fixed in relation to the side module, whereby the design is simplified. If the at least one part of the central module is moved vertically upward or downward, the length of the mobility assistance system thus preferably remains constant. This is advantageous in particular when navigating in constricted spatial conditions, such as an apartment. If the at least one part of the central module is moved in the horizontal direction, the height of the mobility assistance system thus preferably remains constant, and therefore, for example, the mobility assistance system can also be used as a seat.

In particular, the width reduction of the mobility assistance system enables the passage of narrow points, for example, narrow doors and/or passages. The width change is preferably performed temporarily for this purpose and enables the intended use of the mobility assistance system to the user in the wide and also in the narrow state of the mobility assistance system. The mobility assistance system preferably stands stably in this case and in particular does not tend to tip.

The mobility assistance system preferably has a width in the widest state between 70 cm and 40 cm, preferably between 65 cm and 50 cm, and most preferably between 63 cm and 55 cm, wherein the width can be reduced by 20% to 70%, preferably by 25% to 60%, and most preferably by 30% to 50%. The mobility assistance system has a width of approximately 60 cm, for example, in the wide state, the normal operating state. In the state having reduced width, the mobility assistance system has a width of 40 cm, for example, whereby narrow points in an apartment or the surroundings of the user can also be passed.

The at least one part of the central module which is mounted so it is movable in relation to the side module preferably has a wedge shape or a step shape. The central module itself can also have a wedge shape or a step shape. A wedge shape enables a continuous adjustment of the width of the mobility assistance system when this wedge-shaped part, or the central module itself, is moved in the horizontal or vertical direction in relation to the at least one side module. If this wedge-shaped part is moved in a relative manner, the at least one side module preferably thus moves synchronously inward or outward, to change the width of the mobility assistance system.

If the part of the central module and/or the central module itself has a step shape, a discrete adjustment of the width of the mobility assistance system is thus possible. If the stepped part is moved horizontally or vertically in relation to the at least one side module, the at least one side module can thus be moved in the direction of the width of the mobility assistance system during and/or after the horizontal or vertical movement of the stepped part, in order to reduce or increase the width of the mobility assistance system. The width of the mobility assistance system can thus assume at least two different widths. If the stepped part is equipped with multiple steps, differently wide states of the mobility assistance system are thus also possible.

The mobility assistance system preferably furthermore has an actuator element, wherein the actuator element is configured to assist the movement of the at least one part of the central module in relation to the side module, wherein the actuator element preferably comprises a spring element. The changing of the width of the mobility assistance system is simplified for the user by the assistance of the movement of the at least one part of the central module in relation to the side module. For example, the actuator element can compensate for the weight of the part of the central module when it is to be moved vertically. It is also possible that the actuator element compensates for friction forces. The actuator element is preferably configured such that the movement of the at least one part of the central module in relation to the side module is executed by means of the actuator element. The spring element of the actuator element is preferably a mechanical spring, a magnetic spring, and/or the like.

The actuator element preferably comprises an electrical actuator. An electrical actuator enables an assistance of the movement of the at least one part of the central module in relation to the side module, which can take place in a force-regulated and/or position-regulated manner, for example. Moreover, an electrical actuator enables a control of the changing of the width of the mobility assistance system, which can be performed via a suitable control element. The changing of the width of the mobility assistance system can therefore preferably be performed by the (possibly weak/old) user themselves and does not require the part to be moved in relation to the side module to be moved actively by a person or the user.

The central module and/or at least a part of the central module, which is mounted so it is movable in relation to the at least one side module, can preferably be locked, such that a relative movement is not possible. This locking ensures that the width of the mobility assistance system is not unintentionally changed. The locking can take place mechanically, for example, via bolts and/or pins or by suitable brakes, which act on the actuator element.

The mobility assistance system preferably has at least one front axle and one rear axle, wherein the distance between the front axle and the rear axle is in the range of 40 to 70 cm, preferably between 45 and 65 cm, and most preferably between 45 and 55 cm, and wherein the center of gravity of the mobility assistance system is between the front axle and the rear axle, and is preferably at least 20 cm and more preferably at least 25 cm behind the front axle. The distance between the front and rear axle in the specified range enables the provision of a tipping-stable mobility assistance system. In particular, the location of the center of gravity between the front axle and the rear axle enables the user also to use the mobility assistance system for standing up, support, and/or the like, without the user being subjected to a risk of falling due to tipping of the mobility assistance system. Furthermore, the center of gravity location enables the wheels of the front and rear axle to be vertically loaded such that the hazard of slipping away of the mobility assistance system can be precluded or at least reduced even under unfavorable load states. Moreover, sufficient traction can be provided by the center of gravity location at the wheels, in particular those of the rear axle, which is necessary during braking procedures or when traveling over floor irregularities, such as steps.

The mobility assistance system furthermore preferably has at least one additional weight, which is reversibly attached in and/or on the structural frame, wherein the additional weight is preferably a fluid, wherein the fluid is preferably provided in at least one tank.

The mobility assistance system can be adapted further to the person to be assisted by the provision of additional weights. For example, a light person can be assisted using a light mobility assistance system and a heavy person can be assisted using a heavy mobility assistance system. The additional weights can be provided, for example, in the form of fixed, rigid additional weights.

The additional weight is preferably provided, however, in the form of a fluid, which is poured into tanks provided for this purpose. These tanks can be provided, for example, in cavities of the structural frame and/or can be/become fastened on the structural frame itself. To prevent negative effects due to sloshing of the fluid, the tanks are preferably formed segmented and/or having sponge structures. The provision of the additional weight in the form of a fluid enables the mobility assistance system to be transported without having to carry along the additional weight. If the fluid is water, for example, the additional weight can thus be provided at the destination by filling the tanks. In particular, sensors can be provided, which monitor the fill level of the tanks.

Feedback to the user is thus possible, as to whether the tanks are sufficiently filled and/or whether a sufficiently high level of tipping stability is ensured.

The provision of an additional weight also enables the mobility assistance system itself to be constructed as light as possible, in order to ensure a high level of mobility and transportability of the mobility assistance system. The required weight for providing a high level of tipping stability of the mobility assistance system can be provided by the suitable provision of additional weight(s). Furthermore, the mobility assistance system can be operated in an energy-saving manner by the adaptive attachment of additional weights, if only a minor additional weight is necessary. Furthermore, the travel behavior can be improved.

The mobility assistance system preferably weighs at least 50 kg, preferably at least 60 kg, and most preferably at least 75 kg, wherein the central module and the at least one side module each weigh at most 300 kg and preferably at most 25 kg. The tipping stability and traction of the mobility assistance system can be significantly improved by providing a high weight. An allocation of the weight such that the individual modules, i.e., the at least one side module and the central module, do not exceed a maximum weight of 30 or 25 kg, respectively, facilitates the transportation of the mobility assistance system.

The mobility assistance system preferably has at least two driven wheels, which are driven by means of the drive unit, wherein the wheels are preferably differentially driven wheels and are preferably associated with the rear axle. The drive by means of two driven wheels ensures a secure propulsion of the mobility assistance system, even if one of the driven wheels does not have sufficient traction. This can be the case, for example, in the event of damp or soft underlying surfaces. A differential drive of the wheels ensures a high level of maneuverability of the mobility assistance system. The mobility assistance system can thus also be used in narrow rooms and in particular in apartments, which require very small cornering radii, to be able to reach all regions of the room/the apartment.

The mobility assistance system preferably has at least one additional roller, wherein the additional roller is configured to be placed on the floor and roll laterally when the width of the mobility assistance system is changed. The additional roller enables, after the relative movement of the at least one part of the central module, the at least one side part to be moved such that the width of the mobility assistance system is reduced. The lateral movement is a movement in this case in the direction in which the width of the mobility assistance system changes. The additional roller is preferably an omnidirectional wheel, which has circumferentially arranged rollers. Omnidirectional wheels enable the rolling of the wheel in all spatial directions, whereby a high level of maneuverability of the mobility assistance system is achieved. In particular, the mobility assistance system can be easily navigated by means of the additional rollers, even if the drive of the at least one wheel fails or is temporarily not available.

The mobility assistance system preferably has at least one handle, wherein the handle is arranged on the structural frame and is preferably vertically adjustable. In particular, the mobility assistance system has at least two handles. In this case, the user can walk between the handles when the mobility assistance system has assumed the wide state.

If the width has been reduced, the user can thus preferably walk behind or adjacent to the mobility assistance system in order to pass narrow points.

The mobility assistance system is preferably tipping-stable even if a horizontal force of 150 N, preferably 180 N, and most preferably 200 N engages on the handle. The handle is preferably set in this case between 65 cm and 110 cm, preferably between 70 cm and 105 cm, and most preferably between 75 cm and 100 cm high. The above-mentioned tipping stability in the event of horizontal forces of 150 N, preferably 180 N, and most preferably 200 N is achieved in the case of a vertically-adjustable handle/handles when the handle is in the highest position. If the handle is correspondingly set lower, a higher level of tipping stability is thus preferably achieved. If the mobility assistance system is tipping-stable under the mentioned acting forces, a user can thus use the mobility assistance system for standing up and/or support, without being subjected to an elevated risk of falling.

The object is also achieved by a method for changing a width of a mobility assistance system, wherein the method has the following method steps: coupling the central module to two side modules; moving at least a part of the central module in relation to the side modules, wherein the movement direction of the at least one part of the central module is preferably vertical or horizontal; moving the side parts in relation to one another to change a width of the mobility assistance system, wherein the movement of the side parts preferably takes place at least partially simultaneously with the movement of the at least one part of the central module, and preferably subsequently locking the mobility of the at least one part of the central module in relation to the side modules.

The described method enables the mobility assistance system to be changed in its width and thus a user to pass, for example, narrow points.

### DETAILED DESCRIPTION OF THE FIGURES

The invention will be described in greater detail hereafter with reference to the appended figures. In the figures:

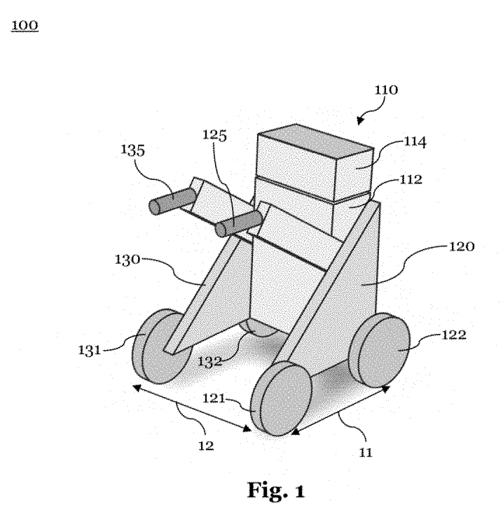

FIG. 1 shows a schematic illustration of a mobility assistance system,

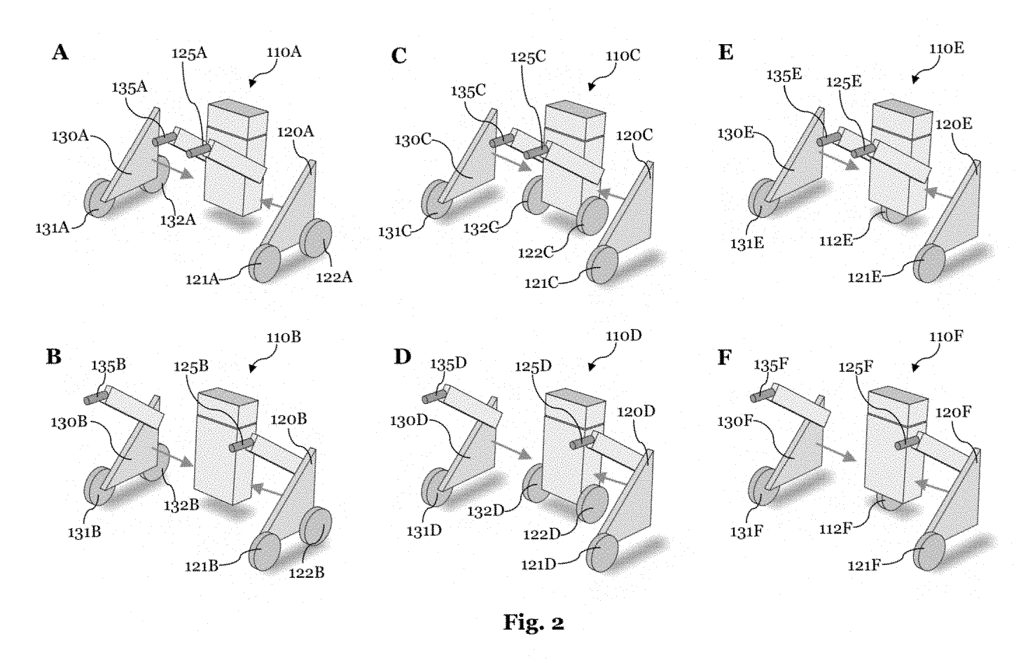

FIGS. 2A to 2F show schematic illustrations of different mobility assistance systems,

FIG. 3 shows a schematic illustration of a mobility assistance system,

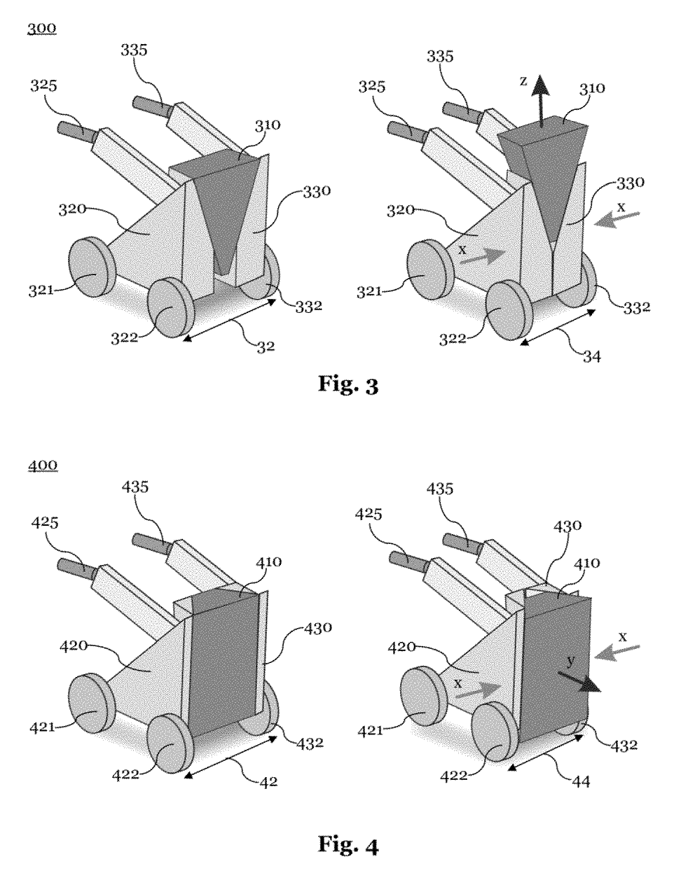

FIG. 4 shows a schematic illustration of a mobility assistance system,

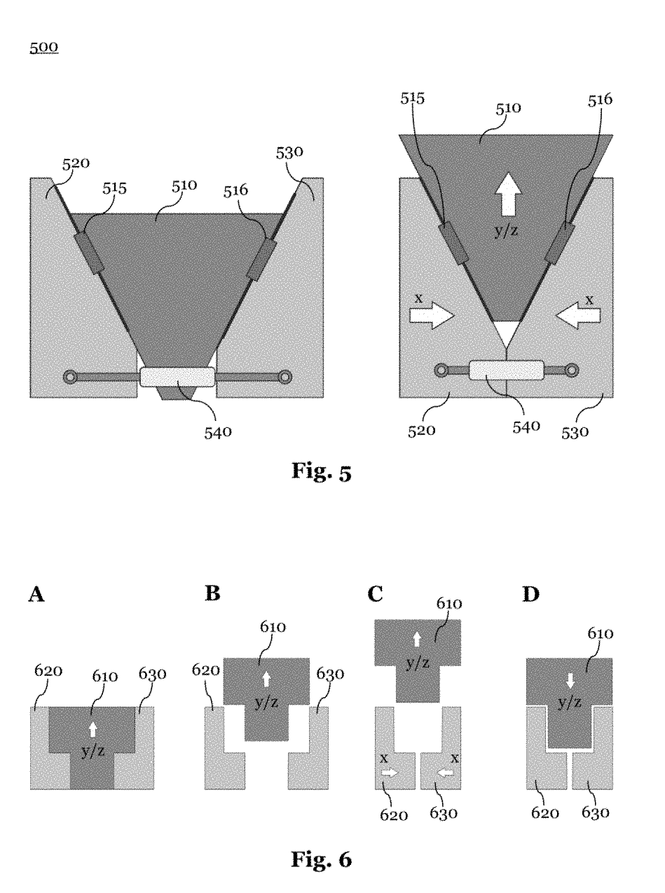

FIG. 5 shows a schematic illustration of a part of a mobility assistance system for changing the width of the mobility assistance system,

FIG. 6A to 6D show schematic illustrations of a mobility assistance system for changing the width of the mobility assistance system,

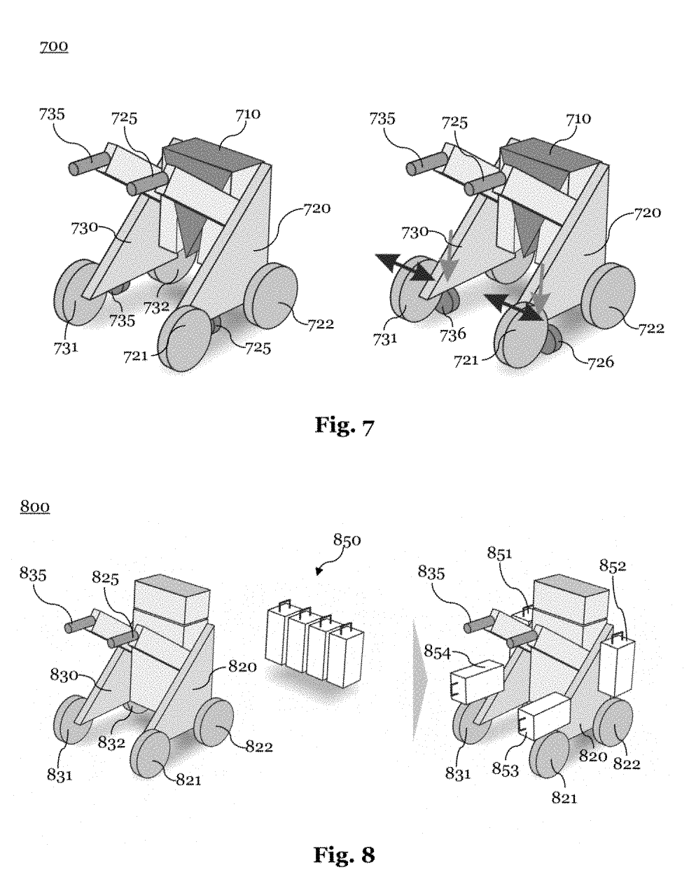

FIG. 7 shows a schematic illustration of a mobility assistance system having additional rollers, and

FIG. 8 shows a schematic illustration of a mobility assistance system having additional weights.

In particular, FIG. 1 shows a mobility assistance system 100, which comprises a modular structural frame, wherein the modular structural frame has one central module 110 and two side modules 120, 130. Each of the side modules 120, 130 has two wheels 121, 122, 131, 132. Two handles 125, 135, between which a user can walk, are attached to the modular structural frame. The central module 110 has a drive unit 112, which comprises, for example, software, electronics, and mechanisms. Furthermore, the central module 110 has an additional module 114, which can be, for example, a seat surface, a basket, and/or the like. The mobility assistance system 10o has an axle distance from the front axle, which is determined by the wheels 122, 132, to a rear axle, which is determined by the wheels 121, 131. Furthermore, the mobility assistance system 10o has a width 12. The mobility assistance system 10o is modularly constructed.

Different module configurations of the mobility assistance system 10o can be seen in FIGS. 2A to 2F. The reference signs of identical numbers identify identical parts in this case. In particular, the mobility assistance system shown in FIG. 2 has one central module 110A-110F, and two side modules 120A-120F, 130A-130F, which each have at least one wheel 121A-121F, 131A-131F. Furthermore, the mobility assistance system comprises at least two handles 125A-125F and 135A-135F.

The mobility assistance systems shown in FIGS. 2A to 2D additionally have wheels 122A-122D and 132A-132D. The mobility assistance system shown in FIGS. 2D and 2F have a wheel 112E, 112F. As can be seen in FIG. 2A, the handles 125A, 135A are associated with the central module 110A. The wheels 121A, 122A, 131A, 132A are associated with the respective side part. In FIG. 2B, the handles 125B, 135B are associated with the side modules 120B, 130B. In FIG. 2C, the handles 125C and 135C and the wheels 122C, 132C are associated with the central module 110C. In FIG. 2D, the handles 125D, 135D are associated with the side modules 120D, 130D and the wheels 132D, 122D are associated with the central module 110D. The embodiments of FIGS. 2E and 2F each only have one front wheel 112E, 112F. This front wheel 112E, 112F is associated with the respective central module 110E, 110F. The handles 135E, 125E from FIG. 2E are associated with the central module 110E. The handles 135F, 125F are associated with the side modules 130F or 120F, respectively. The respective side modules 130A-130F and 120A-120F can be connected via interfaces to the respective central module 110A-110F. The interfaces are preferably mechanical and/or electronic interfaces and are used, for example, for transmitting data and/or drive power. The modules can preferably be coupled without tools by means of the interfaces.

FIG. 3 shows a mobility assistance system 300, which comprises one central module 310 and two side modules 320, 330. The mobility assistance system 300 furthermore has rear wheels 321 and two front wheels 322, 332. Moreover, the mobility assistance system 300 has two handles 325, 335. The mobility assistance system 300 can be changed in its width 32, 42, wherein the left schematic illustration shows the mobility assistance system 300 in a wide state and the right illustration shows the mobility assistance system 300 in a state having reduced width 34. To change the width 32, 34 of the mobility assistance system 300, the wedge-shaped central module 310 is moved vertically upward (z direction) in relation to the side modules 320, 330. The side modules 320, 330 are moved laterally, in the x direction toward one another along the direction of the width 32, 34, and the width 32 is thus changed to the narrow, reduced width 34. This width change is reversible. The width change can take place continuously due to the wedge shape of the central module 310.

FIG. 4 shows a mobility assistance system 400, which has one central module 410 and two side modules 420, 430. Moreover, the mobility assistance system 400 comprises two rear wheels 421 and two front wheels 422, 432 and the handles 425, 435. In the wide state, the mobility assistance system 400 has a width 42. In the state having reduced width, the mobility assistance system 400 has a width 44. To change the width of the mobility assistance system 400, the wedge-shaped central module 410 is moved in the horizontal direction, perpendicularly to the width in relation to the side modules 420, 430. After the relative movement of the central module 410, the side modules 420, 430 can be moved toward one another in the X direction and the width can be reduced.

This procedure is also reversible. The mobility assistance systems 300, 400 can be used both in the wide state and also in the narrow state to assist a user. In particular in the wide state, the user can walk between the handles 325, 335; 425, 435.

FIG. 5 schematically shows a mechanism for changing the width of a mobility assistance system 500 in a top view from above, wherein the mechanism comprises one wedge-shaped central module 510 and two side modules 520, 530. The central module 510 is mounted so it is movable in relation to the side modules 520, 530. For this purpose, bearings 515, 516 are attached between the central module 510 and the side modules 520, 530. An actuator element 540, which preferably comprises a spring element and/or an electrical actuator, assists the relative movement of the central module 510.

If the central module 510 is moved in the y direction or z direction, the side modules 520, 530 can thus be moved in the x direction in order to reduce the width of the mobility assistance system. The wedge shape of the central module 510 enables a continuous adjustment of the width 42, 44.

FIG. 6 shows a further mechanism for adjusting the width of a mobility assistance system, wherein the central module 610 is embodied as stepped. In the wide state (FIG. 6A), the central module 610 is introduced completely between the side modules 620, 630. To adjust the width, firstly the central module 610 has to be moved in the Y direction or Z direction (FIG. 6B). After the completion of the movement (FIG. 6C), the side modules 620, 630 are moved toward one another in the X direction. Subsequently, the central module 610 can be partially introduced between the side modules 620, 630. As can be seen in FIG. 6D, the mobility assistance system is then provided in a state having reduced width.

FIG. 7 shows a mobility assistance system 700, which has one central module 710 and two side modules 720, 730. The mobility assistance system 700 furthermore has two handles 725, 735 and two rear wheels 721, 731 and two front wheels 722, 732. The central module 710 is wedge-shaped. To enable a lateral movement of the side modules 720, 730, additional rollers 726, 736, which are preferably oriented perpendicularly to the rear wheels 721, 731, are attached to the side modules. To be able to move the side modules 720, 730 laterally, the additional rollers 726, 736 are moved downward, so that they come into contact with the floor. The rear wheels 731, 721 are preferably raised at the same time. By rolling the additional rollers 726, 736 toward one another, the side modules 720, 730 can be moved toward one another. The additional rollers 726, 736 are preferably omnidirectional rollers, such that the mobility assistance system 700 can be easily navigated even with shut-down drive.

FIG. 8 shows a mobility assistance system 800, which can be provided with at least one additional weight 850. The mobility assistance system 800 comprises one central module 810 and at least two side modules 820, 830. Furthermore, the mobility assistance system 800 comprises the wheels 821, 822, 831, 832 and the handles 825, 835. The additional weights 851, 852, 853, 854 can be attached to the modular structural frame of the mobility assistance system 800 to adapt the weight of the mobility assistance system 80000 to a user. The additional weights 851, 852, 853, 854 are preferably tanks which can be filled with fluid. The tanks preferably have a segmentation and/or are filled by a sponge structure, and therefore sloshing of the fluid can be prevented.

### LIST OF REFERENCE SIGNS

100, 200, 300, 400, 500, 700, 800 mobility assistance systems
110 central module
120, 130 side module
112 drive unit
114 additional module
121, 122, 131, 132 wheels
125. 135 handles
11 axle distance
12 width
110A-110F central module
120A-110F, 130A-130F side module
131A-131F, 132A-132F,
121A-121F, 122A-122F wheels
125A-125F, 135A-135F handles
112E, 112F wheels
310, 420, 510, 710 wedge-shaped central module
420, 430, 520, 530, 720, 730 side module
321, 322, 332, 421, 422, 432, 731, 721, 722 wheels
325, 335, 425, 435, 725, 735 handles
z vertical direction
x, y horizontal direction
32, 42 width
34, 44 reduced width
610 stepped central module
620, 630 side module
810 central module
820, 830 side module
825, 835 handles
821, 822, 831, 832 wheels
850 additional weights
851, 852, 853, 854 additional weight
726, 736 additional rollers

1. A mobility assistance system, comprising:
a drive unit, which is configured to drive at least one wheel of the mobility assistance system;
a modular structural frame, wherein the modular structural frame comprises a central module, and also at least one side module, wherein the drive unit is arranged in the central module or the at least one side module, and wherein
the at least one wheel is associated with the side module; and
the central module and the at least one side module each have at least one interface, by means of which the central module can be reversibly coupled mechanically or electronically to the at least one side module.

2. The mobility assistance system as claimed in claim 1, wherein the at least one interface of the central module and the at least one side module comprises at least one of a data interface or drive power interface.

3. The mobility assistance system as claimed in claim 1, wherein the at least one interface of the central module and the at least one side module is a quick-mounting interface, which is configured to couple the central module to the at least one side module without tools.

4. The mobility assistance system as claimed in claim 1, wherein at least a part of the central module, when the central module is coupled to the at least one side module and is mounted so it is vertically or horizontally movable in relation to the side module, to change a width of the mobility assistance system, wherein the horizontal movement of the at least one part of the central module preferably takes place perpendicularly to the width.

5. The mobility assistance system as claimed in claim 1, wherein the width of the mobility assistance system in the widest state is between 70 cm and 40 cm, and can be reduced by 20% to 70%.

6. The mobility assistance system as claimed in claim 4, wherein at least the part of the central module which is mounted so it is movable in relation to the side module has a wedge shape or a stepped shape.

7. The mobility assistance system as claimed in claim 4-6, further having an actuator element, wherein the actuator element is configured to assist the movement of the at least one part of the central module in relation to the side module.

8. The mobility assistance system as claimed in claim 7, wherein the actuator element comprises an electrical actuator.

9. The mobility assistance system as claimed in claim 1, wherein the mobility assistance system comprises at least one front axle and one rear axle, wherein
the distance (11) between the front axle and the rear axle is in the range of 40 cm to 70 cm, and wherein
the center of gravity of the mobility assistance system is between the front axle and the rear axle.

10. The mobility assistance system as claimed in claim 1, wherein the mobility assistance system further has at least a weight which is reversibly attached to the structural frame.

11. The mobility assistance system as claimed in claim 1, wherein the mobility assistance system weighs at least 50 kg, wherein the central module (110) and the at least one side module, each weigh at most 30 kg.

12. The mobility assistance system as claimed in claim 9, wherein the mobility assistance system has at least two driven wheels, which are driven by means of the drive unit.

13. The mobility assistance system as claimed in claim 1, wherein the mobility assistance system has at least one roller is configured to be placed on the floor and roll laterally when the width of the mobility assistance system is changed.

14. The mobility assistance system as claimed in claim 1, wherein the mobility assistance system has at least one handle, wherein the handle is arranged on the structural frame and is vertically adjustable.

15. The mobility assistance system as claimed in claim 15, wherein the mobility assistance system is tipping-stable when a horizontal force of between 150 N and 200 N engages on the handle.

16. A method for changing a width of a mobility assistance system, wherein:
the mobility assistance system comprises a drive unit configured to drive at least one wheel of the mobility assistance system and a modular structural frame having a central module and two side modules,
the drive unit is arranged in the central module or in one of the two side modules,
the at least one wheel is associated with one of the two side modules, and
the central module and each of the two side modules have interfaces, by means of which the central module can be reversibly coupled mechanically or electronically to each of the two side modules,
the method comprising the following method steps:
coupling the central module to the two side modules;
moving at least a part of the central module in relation to the side modules, wherein the movement direction of the at least one part of the central module is vertical or horizontal;
moving the two side modules in relation to one another to change a width of the mobility assistance system, wherein the movement of the side parts runs at least partially simultaneously with the movement of the at least one part of the central module.

17. The mobility assistance system as claimed in claim 7, wherein the actuator element comprises a spring element.

18. The mobility assistance system as claimed in claim 10, wherein the weight comprises preferably a fluid provided in at least one tank.

19. The mobility assistance system as claimed in claim 12, wherein the wheels are differentially driven wheels and are associated with the rear axle.

20. The method as claimed in claim 16, further comprising the additional step, subsequent to the moving steps, of locking the mobility of at least one part of the central module in relation to the side modules.
